(19) United States
(12) Patent Application Publication
(10) Pub. No.: US 2010/0163534 A1
(43) Pub. Date: Jul. 1, 2010

(54) ATMOSPHERIC-PLASMA PROCESSING METHOD FOR PROCESSING MATERIALS

(76) Inventors: Claudia Riccardi, Milano (IT); Paola Esena, Milano (IT); Ruggero Alfredo Barni, Milano (IT); Riccardo Siliprandi, Milano (IT); Stefano Zanini, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/449,581

(22) PCT Filed: Feb. 21, 2008
(86) PCT No.: PCT/IT2008/000115

§ 371 Date: Feb. 2, 2010

(30) Foreign Application Priority Data
Feb. 23, 2007 (IT) MI2007A000350

(51) Int. Cl. H05H 1/24

(52) U.S. Cl. 219/121.59

(57) ABSTRACT

A plasma treatment method for processing a material includes a step of subjecting the material to a substantially atmospheric-pressure plasma, thereby obviating the need of providing expensive vacuum apparatus and pumping assemblies, while facilitating a continuous and quick treatment even in a controlled working environment. Depending on the materials to be processed, several processing methods can be used.

### BACKGROUND OF THE INVENTION

The present invention relates to an atmospheric-plasma treatment processing method for processing materials in general.

As is known, plasma-process based technologies or methods are of basic importance in a lot of industrial fields, and, mainly, in the microelectronic field, where they have become nearly indispensable.

Other exemplary fields in which the above technologies or methods are advantageously used are the aerospace, automotive, steel making, waste processing and biomedical fields, in which, by using plasma processes, it is possible, for example, to harden surfaces, change optical properties, neutralize noxious substances and improve the biocompatibility of the materials being processed.

A surface modification of said materials by subjecting them to plasmas has in general several advantages with respect to like conventional chemical processes.

In fact, the plasma processes are dry processes which do not require solvent or chemical products, which would be susceptible to represent a danger for the environment and, moreover, the modifications provided by the above mentioned plasma processes, affect only surface layers of a sublayer or substrate, and do not alter the general physical-mechanical properties of the materials being processed.

The most part of the industrial plasma processes are carried out in low pressure rarefied gases (generally at a pressure from 10⁻⁴ to few tens of mbars), by exploiting vacuum methods.

Under these conditions, a very even plasma, the so called “glow discharge” plasma, is obtained.

Such a plasma is usually generated by applying an electric field to the rarefied gas.

The electric field may be either a continuous or an alternating one, with operating frequencies varying from microwave to optical radiation (laser) frequencies.

Several types of ions, electrons and neutral radicals able of reacting with the surface of the material to be processed, are generated in the plasma, such technology or processing method being very advantageous since it uses very small amounts of reactive gases and is carried out under a controlled environment (the vacuum chamber) adapted to insulate the processing zone from the environmental atmosphere.

However, a great limitation is that of using vacuum technologies which, in addition to being very expensive, do not allow the target material to be continuously processed; moreover they require long waiting times to bring the processing chamber to a low pressure, by specifically designed pumping assemblies.

In this connection it should be pointed out that, for continuously processing materials, some technological approaches have been already proposed.

According to the above approaches, a plurality of communicating vacuum chambers are held at different pressures, to gradually bring the environment to a target working pressure.

However, such a solution does not reduce, but increases, the overall cost of the processing apparatus, because of the very great difference between the atmospheric pressure and the processing chamber pressure; moreover, such a solution is not easily adaptable to highly degasifying materials, such as, for example, leather, fabric and paper materials.

### SUMMARY OF THE INVENTION

Accordingly, the aim of the present invention is to provide such a processing method which can be used for atmospheric-pressure applications.

Within the scope of the above mentioned aim, a main object of the invention is to provide such an atmospheric-plasma processing method, for processing materials in general, allowing to overcome the requirement of using expensive vacuum apparatus and related pumping assemblies, while allowing to facilitate continuous processing operations, even if it is necessary to operate under a controlled environment.

A further object of the present invention is to provide such an atmospheric-plasma processing method, for processing materials in general, allowing to use much more inexpensive technologies, while providing generally quicker processes.

According to one aspect of the present invention, the above mentioned aim and objects, as well as yet other objects, which will become more apparent hereinafter, are achieved by a plasma processing method for processing materials in general, characterized in that said method comprises the step of subjecting a material to be processed to a substantial atmospheric-pressure plasma.

Further characteristics and advantages of the present invention will become more apparent hereinafter from the following disclosure of preferred, though not exclusive, embodiments of the invention.

Atmospheric-Pressure Processes

Atmospheric-pressure cold plasmas can be generated in several manners, by applying a potential difference (generally from 100 V to tens of kV) between two electrodes.

The applied current may be either a DC current or an AC current, with a frequency variable from microwave to laser radiation frequencies.

The materials to be processed can be exposed to the plasma both near the discharge zone, that is in a direct contact with the electrodes or in an intermediate position therebetween (a so-called near or close process) or it is possible to generate the plasma between two electrodes and then convey it, by a gas flow, on the surfaces to be processed (a so-called remote process).

Thus, the substrata are not directly exposed to the discharge.

Several gases can be experimentally used such as: nitrogen, noble gases, oxygen, hydrogen, fluorinated gases in general (SF₆, SOF₂, and so on), gaseous hydrocarbons (CH₄, C₂H₂, and so on), gaseous fluorocarbons (CF₄, C₂F6, and so on). It is also possible to use mixtures of the above mentioned gases.

By using a liquid-phase compound vaporization system, it is further possible to mix to the above mentioned gases water steam, ammonia hexamethyl-disiloxane (HMDSO) vapors, and other silane, siloxane, hydrocarbon and perfluorinated compounds.

It is possible to achieve all the gas (or gas mixture) vapor concentration ranges, up to a saturation concentration (i.e. that concentration for which a liquid is an equilibrium condition with its vapor at a given temperature and pressure) of said liquids, under the temperature and pressure conditions which are used in experiments or trials.

It is also possible to use colloidal dispersion (aerosol) generating systems, adapted to mix to the process gases liquid compounds (as above disclosed) or solid compounds (including micro and nano particles).

Depending on the materials being processed and the contingent requirements, it is possible to use several processing methods, in which:

1—The plasma exposure step is preceded by a degassing step, in which, by using a vacuum chamber, the samples are brought to a limit pressure from 10⁻⁷ to 10 mbars, preferably from 10⁻³ to 1 mbar.

Then, the processing chamber is filled-in by the gas (or gas mixture) so as to achieve the working pressure which is held by evacuating the chamber by a suitable pumping system.

2—The plasma exposure step is a process in which the materials (such as film, fabric, leather materials) are continuously processed by holding the processing chamber under an overpressure condition (from patm+0.1 to 1200 mbars in general) where patm is the atmospheric pressure under the working conditions) with respect to the outer environment, to prevent any contaminations from occurring.

3—The plasma exposure step represents a continuous treatment in which the materials are filled-in in the processing chamber through pre-chambers which are optionally held at an always less pressure. The treatment is carried out under a slight underpressure (from 800 to pₐₜₘ−0.1 mbar), thereby preventing possibly noxious gases from exiting the processing chamber.

In the procedures 2 and 3, the material supplied to the processing chamber is at first subjected to a contaminating gas evacuating system and/or a gas washing inner system using inert gases (such as nitrogen) and/or a heating (drying) system for eliminating contaminations due to material adsorbed gases and steam. By the above mentioned procedures, it is possible to carry out several treatments adapted to provide hydrophobic, oil repellency, gas and steam barrier, hydrophilic, antisticking releasing, antistaining and antiageing properties, as well as an increase of the printing yield and of the dyeing capability, as well as other properties which were conventionally obtained by low pressure plasma processing methods.

The trials have been performed by using extended and localized sources, both of a direct and of a remote type.

For example, an atmospheric pressure DBD discharging (that is a “Dielectric Barrier Discharge”) in which the plasma is produced at a low frequency between two conductor electrodes has been used for the above purpose.

Generally, one of the electrodes, or both, may be coated by a dielectric material.

For carrying out this treatment an apparatus comprising a current source and an electrode system is generally used, with the current source generally operating at voltages from 100 V to 20 kV, and AC currents substantially from DC to 10 MHz.

The electrode system generally comprises a discharging electrode to which the high voltage is applied, and a grounded electrode, one or both of which may be coated by a dielectric material. The grounded electrode may comprise a roller on which the material to be processed is caused to continuously slide, the distance between the electrodes being usually of few millimeters.

The discharging can occur at a pressure variable from 500 to 1500 mbars, preferably from 800 to 1200 mbars, and the power being transferred by the discharge for unit surface of the material being processed being expressed by the so-called “corona dose” [W. Min/m²], defined as:

$$corona dose ( D ) = \frac{Power of the generator ( P )}{electrode width \times sliding speed ( V )}$$

The samples are arranged at a variable distance from the electrodes, which can vary from 0.1 to 40 mm, preferably from 1 to 10 mm.

The samples can be driven with a driving speed from 0.1 to 200 m/min, preferably from 1 to 100 m/min, by an automatic driving system, while allowing a continuous type of process to be easily carried out.

The samples can be processed from 1 to 100 times, preferably from 1 to 10.

The corona dose for each individual treatment can be at maximum of 3,000 W. min/m², preferably from 30 to 1,000 W. min/m². Another example of a cold plasma source to be used would be a remote plasma source.

The above apparatus generally comprise an electrically grounded hollow electrode, including therewithin the high voltage electrode, said hollow electrode defining a cavity therethrough the process gas is caused to flow for convectively convey, through a conveying nozzle, the plasma generated chemical species on the surface being treated.

The voltage generally varies from 0.2 to 20 KV, the AC current having a frequency from DC to 20 MHz. The gas flow rates will vary from hundreds sccm's to hundreds 1ₙ/min, depending on the source size and type (for example either an extended or point-like source).

Since the discharging region is usually held by the gas flow devoid of any contaminations, it is possible to use a chamber-less source, or a slightly underpressurized or overpressurized chamber source to prevent possibly noxious gases from leaking therefrom.

Thus by using the above atmospheric pressure plasmas, several types of materials can be easily and quickly treated, such as paper, fabric, leather, polymeric film, metal, stone, cellulose fiber and wood material s in general.

The above methods provide the following modes of operation:.

A—A direct use in a plasma phase of the chemical precursor designed to provide the target surface properties, which chemical precursor, if necessary, can also be mixed as a vapor (aerosol) or colloidal dispersion with the above carrier gas.

B—As a liquid phase, a gas, a vapor or a colloidal dispersion (aerosol, emulsion, sol) precursor to be applied before the plasma treatment.

C—As a liquid, gas, vapor, or colloidal (aerosol, emulsion, sol, and so on) dispersion precursor to be applied during the plasma treatment.

The above mode of operation being also designed to be combined with one another.

Example 1: it is possible to preliminary expose the materials either to a liquid, gaseous phase, or to a gas and vapor mixture treatment, and then to a finishing plasma treatment by using noble gases (b).

Example 2: it is possible to use a plasma process to activate the surface before subjecting the latter to an active treatment, either in a liquid or gaseous form, or as a vapor mixture or a colloidal (aerosol, emulsion, sol, and so on) dispersion (c).

Example 3: it is possible to use a plasma treatment to activate the target surface and increase the efficiency of a second plasma treatment, (a+a).

Further combinations of the above disclosed treatment can also be provided to achieve surface multifunctional properties.

Some examples of treatments to be performed on materials such as paper, paperboard, fabric and leather materials will be now thereinbelow disclosed, for providing desired surfaces with hydrophobic, oil repellency and hydrophilic properties, or further improved surface properties, such as antistaining, antisticking, releasing and antiageing properties, as well as enhanced dying, printing, resin and glue adhering properties.

### PAPER TREATMENT EXAMPLES

### Example 1

### Water-Repellency

Different paper surfaces made of paper materials of different basic weights have been processed, by using the following parameters:

Corona Dose: 750 W.min/m²

Pressure: 900 mbars

Gas Carrier (N2):2 lₙ/min

HMDSO: 1.2 g/h (H20 equiv.)

Treatment number: 8

Results:

The results have been analyzed by several methods, such as:

Analysis method 1: Cobb₆₀

The surface of the sample has been held contacting a distilled water layer of a height of 1 cm for 60 seconds, and the water grams absorbed by the sample have been determined by weighing the sample before and after the test. The result is expressed in grams/m².

Analysis Method 2: Contact Angle

The contact angle (expressed in degrees) between a droplet of a liquid and the surface of the sample has been determined by a suitable digital goniometer.

The surfaces of the processed samples were hydrophobic, as shown in Table 1.

TABLE 1
Water repellency: Cobb₆₀ and water contact angle

| | Non processed | | Processed | |
|---|---|---|---|---|
| Sample | Cobb₆₀ | Contact angle | Cobb₆₀ | Contact angle |
| Unglued paper | 210 | 60.2 | 16.5 | 111.2 |
| 100 g/m² | | | | |
| Unglued paper | 65 | 30.5 | 18 | 109.0 |
| 50 g/m² | | | | |
| Cart | 320.0 | 68.8 | 24.2 | 107.1 |
| 250 g/m² | | | | |

### Example 2

### Water/Oil Repellency

Different paper surfaces, made of paper materials of different basic weights, have been pre-treated as in Example 1, and then subjected to a different reactive gas (SF₆) plasma, with the following parameters:

Corona Dose: 750 W.min/m²

Pressure: 900 mbars

Gas Mixture: Sulphur hexafluoride (SF₆) at 2% in Helium

Treatment number: 8

Results:

The processed sample surfaces were water and oil repellent. The water repellency has been evaluated by Example 1 methods, whereas the oil repellency has been evaluated by the Analysis Method 3: test KIT and polar test KIT according to the TAPPI T 559 method.

The obtained results have been shown in Tables 3 and 4.

### Example 3

### Water/Oil Repellency

An unglued paper having a basic weight of 50 g/m² has been exposed to a liquid phase chemical treatment and then further exposed to a plasma treatment.

Liquid Phase:

Solution: 100 g/l tetrahydroperfluorodecyl-acrylate in ethanol

Immersion time: 10 seconds

Plasma Treatment:

The plasma exposure phase was preceded by a degassing operation in which the processing chamber was brought to a pressure of 10-2 mbars. The treatment parameters are as follows:

Corona Dose: 900 W.min/m²

Pressure: 900 mbars

Gas (Argon): 10 In/min

Treatment number: 5

The processed samples were further washed in ethanol.

Results:

The results have been evaluated by the Analysis Method 3 (test KIT). An untreated sample has a null test KIT value (test KIT and polar test KIT both equal to 0). The sample treated only in a liquid phase, also provides a null test KIT value (test KIT and polar test KIT both equal to 0). The sample treated by the two combined treatments (liquid and plasma treatments) provides test KIT and polar test KIT values of respectively 8 and 3.

Fabric Treatment Examples

### Example 4

### Water Repellency

Corona Dose: 790 W.min/m²

Pressure: 950 mbars

Gas Carrier: (N2):2 lₙ/min

HMDSO: 1.2 g/h (H20 equiv.)

Treatment number: 8

Analysis method 4: Time for Absorbing a Water Droplet

A bidistilled and deionized 20 μl water droplet is deposited on the surface under standard atmospheric condition. The total absorption droplet time is measured.

Results:

A non treated silk fabric absorbs instantaneously a water droplet, as determined by the analysis method 4. After treatment, the absorption time is of 15 min and 15 sec.

### Example 5

### Water Repellency

Used parameters:

Corona Dose: 750 W.min/m²

Pressure: 950 mbars

Gas Carrier (N2):2 lₙ/min

HMDSO: 1.6 g/h (H20 equiv.)

Treatment number: 8

Results:

A non treated PET fabric material absorbs a water droplet, according to the analysis method 4, in a time of 4 min and 50 sec. After treatment, the droplet evaporates thereby it is not absorbed.

### Example 6

### Water/Oil Repellency

Used parameters:

Corona Dose: 800 W.min/m²

Pressure: 900 mbars

Gas mixture: Sulphur Hexafluoride (SFO at 2% in Helium

Treatment number: 8

Results:

An untreated hydrophilic cotton fabric instantaneously absorbs a water droplet (according to the Analysis Method 4). After treatment, the droplet evaporates and is not absorbed.

### Example 7

### Hydrophily

Used parameters:

Corona Dose: 190 W.min/m²

Pressure: 1,000 mbars

Gas Mixture: Aria

Treatment number: 8

Results:

An untreated raw cotton fabric absorbs a water droplet in a time greater than 20 minutes (according to the Analysis. Method 4.

After treatment, the droplet is immediately absorbed.

Leather Material Treatment Example

### Example 8

### Water Repellency

Different leather materials have been subjected to a plasma to evaluate the application properties of the treatment for several types of starting animals, tanning, processing stage and finishing.

For example, samples of suede kid skin (Sample A and Sample B) and lamb skin (Sample C) have been exposed to a plasma.

Said samples, in particular have been exposed to a plasma of a hexamethyl disiloxane and nitrogen mixture, according to the following operating parameters:

Corona Dose: 150 W.min/m²

Pressure: 900 mbars

Gas Carrier (N2) :2 lₙ/min

HMDSO: 1.2 g/h (H20 equiv.)

Treatment number: 8

Results:

The surface of the treated samples is much more water-repellent than that of the untreated samples. To evaluate the absorption property, the time for absorbing a 20 μl water droplet under standard pressure, temperature and moisture (Analysis Method 4) conditions has been measured.

For the Sample A, the absorption time, before treatment, was of 2 minutes, whereas, after treatment, it was not possible to observe an absorption up to the evaporation time of the droplet. For the Sample B, the absorption time increased from 7 to 40 minutes, and for the Sample C it increased from 1 to 15 minutes.

### Example 9

### Water/Oil Repellency

Several leather or skin materials, to evaluate the applicability of the treatment to several types of starting animals, tanning, working stage and finishing, have been exposed to a plasma comprising a sulphur hexafluoride (SF₆) and Helium (He) mixture with the following parameters:

Corona Dose: 750 W.min/m²

Pressure: 900 mbars

Gas mixture: Sulphur hexafluoride (SF₆) at 2% in Helium

Treatment number: 8

Results:

The surface of treated samples is much more water repellent than that of the untreated samples.

To evaluate the absorption property, the absorption time of a 20 μl water droplet under standard pressure, temperature and moisture (Analysis Method 4) has been measured.

For example, an untreated lamb skin (vegetal+chromium tanning, dyed crust stage) absorbs a droplet in 3 minutes, whereas after treatment it absorbs the droplet in 12 minutes.

An untreated lamb skin (chromium tanning, crust stage) absorbs the droplet in 1 minute and 20 seconds, whereas, after treatment, it absorbs the droplet within 16 minutes.

### Example 10

### Hydrophily

Different types of skins, to evaluate the applicability of the treatment to several types of starting animals, tanning, working and finishing stage, have been exposed to an atmospheric pressure air plasma.

The surface of the treated samples has been found to be much more hydrophilic than that of untreated samples, thereby providing an enhanced efficiency of the skin or leather printing, ink jet printing and dyeing processes.

To evaluate the absorption properties, the absorption time of a 20 μl water droplet under standard pressure, temperature and moisture conditions (Analysis Method 4) has been measured.

Some results for different skins and treatments are shown in Table 2.

TABLE 2
Hydrophily: Absorption of a droplet

| | | | Untreated | Treated |
|---|---|---|---|---|
| | Corona | | sample | samples |
| | Dose | Treatment | absorption | absorption |
| Sample | [W · min/m²] | No. | time [mim] | time [sec] |
| Kid skin | 45 | 20 | 2.5 | 3 |
| Goat skin | 90 | 20 | 6 | 6 |
| Kid suede | 180 | 30 | 22.5 | <1 |
| skin | | | | |

It has been practically found that the invention fully achieves the intended aim and objects.

In fact, the invention provides an atmospheric plasma processing method for treating materials, that is a method which can be used in atmospheric pressure plasma applications.

The atmospheric pressure generated plasma overcome the need of using expensive vacuum apparatus and related pumping assemblies, while allowing to easily perform continuous treatments, even if under a controlled environment.

In fact, the small pressure difference between the working pressure and the outside pressure, allows to use much more inexpensive technologic solutions, in addition to providing generally quicker processes.

In practicing the invention, the used materials, as well as the contingent size can be any, depending to requirements.

1-30. (canceled)

31. A plasma processing method for processing materials in general, comprising the step of subjecting at least a surface of a material to be processed to a substantially atmospheric pressure plasma.

32. The method according to claim 31, wherein the material to be processed is subjected to said plasma near a discharge region, either in direct contact with electrodes or in an intermediate position between said electrodes.

33. The method according to claim 31, wherein said plasma is generated between two electrodes and conveyed, by a gas flow, on said surface to be processed, whereas substrate portions of said material are not directly subjected to a discharge.

34. The method according to claim 31, wherein said plasma is generated by one or more of the following gases: nitrogen, noble gases, oxygen, hydrogen, fluorinated gases, SF₆, SOF₂, gaseous hydrocarbons, CH₄, C₂H₂, gaseous fluorocarbons, CF₄, and C₂F₆.

35. The method according to claim 31, comprising using a vaporizing system of a liquid compound mixed with gases, said liquid compound being selected from water, steam, ammonia hexamethyldisiloxane, xilane compounds, xiloxane, hydrocarbon and perfluorinated compound vapors.

36. The method according to claim 35, wherein said vapors have a gas or gas mixture concentration up to a saturation concentration of said liquid compound, that is, a concentration at which said liquid compound is in an equilibrium status with a vapor thereof at a given temperature and pressure at target temperature and pressure conditions.

37. The method according to claim 31, comprising using colloidal dispersion and aerosol generation systems capable of being adapted to provide a process gas and liquid or solid compounds mixture, said solid compounds comprising micro and nano particles.

38. The method according to claim 31, wherein the plasma exposure step is preceded by a degassing step in which, by using a vacuum chamber, treated samples are brought to a limit pressure from 10⁻⁷ to 10 mbars, or from 10⁻³ to 1 mbar;
said chamber being supplied with said gas or gas mixture to achieve a target working pressure.

39. The method according to claim 38, wherein in the plasma exposure step, said materials comprising a film, fabric, leather or skin material, is continuously treated by holding a working chamber under an overpressure condition of pₐₜₘ+0.1 to 1,200 mbars, where pₐₜₘ is a working atmospheric pressure.

40. The method according to claim 38, wherein, in the plasma exposure step, said material is supplied to a processing chamber through a plurality of prechambers held at a lower pressure than that of said processing chamber, the treatment being performed under a slight underpressure, or from 800 to pₐₜₘ−0.1 mbar, to prevent noxious gases from exiting said processing chamber.

41. The method according to claim 38, wherein said material supplied to a processing chamber is preliminarily treated by an evacuating system for evacuating contaminating gases and/or to a washing system using washing inert gases or nitrogen, and/or to a heating and drying system.

42. The method according to claim 31, wherein said plasma exposure step is provided with water and oil repellency, gas barrier or water steam, hydrophilic, antisticking, antistaining and antiageing properties, thereby increasing a printing and dyeing yield thereof.

43. The method according to claim 31, comprising using an atmospheric pressure dielectric barrier discharge for generating said plasma at a low frequency between two conductive electrodes.

44. The method according to claim 43, wherein at least one of said electrodes is coated by a dielectric material.

45. The method according to claim 31, comprising using an apparatus comprising a voltage and current source and an electrode system, said current source providing voltages from 100 V to 20 kV, and an AC current from DC to 10 MHz, said electrode system comprising a high voltage discharging electrode and a grounded electrode.

46. The method according to claim 45, wherein said grounded electrode comprises a roller thereon whereby said material is caused to continuously slide, said electrodes being spaced from one another by few millimeters.

47. The method according to claim 45, wherein said discharging electrode provides an electric discharge at a pressure variable from 500 to 1,500 mbars or from 800 to 1,200 mbars.

48. The method according to claim 45, wherein said material is arranged at a distance from said electrodes of 0.1 to 40 mm or 1 to 10 mm.

49. The method according to claim 31, wherein said material is driven by an automatic driving system with a driving speed of 0.1 to 200 m/min or 1 to 100 m/min.

50. The method according to claim 31, wherein said material is processed for 1 to 100 processing times or from 1 to 10 processing times.

51. The method according to claim 31, wherein said material is processed by a corona dose, defined as
$$corona dose ( D ) = \frac{Power of the generator ( P )}{electrode width \times sliding speed ( V )}$$
said corona dose having, for each treatment of said material, a value of max 3,000 W.min/m² or a value of 30 to 1,000 W. min/m².

52. The method according to claim 31, wherein said plasma is a cold plasma provided by a remote cold plasma source comprising an electrically grounded hollow electrode having a hollow electrode cavity comprising a high voltage electrode and gas flows therethrough to convectively convey a chemical species generated in said plasma on said surface.

53. The method according to claim 52, wherein said high voltage varies from 0.2 to 20 KV with an AC current having frequency from DC to 10 MHz, said gas being supplied with flow rates from hundreds sccm's to hundreds 1ₙ/min.

54. The method according to claim 31, wherein said material is a paper, fabric, leather, skin, polymeric film, metal, stone, lignocellulose fiber or wood fiber material.

55. The method according to claim 31, comprising pretreating said material by a chemical precursor capable of being adapted to provide said material with target surface properties either directly in a plasma phase or in a vapor, aerosol, colloidal or dispersion mixed status.

56. The method according to claim 55, wherein a liquid, gas, or colloidal dispersion precursor is preliminarily used in a plasma treatment operation.

57. The method according to claim 55, wherein a liquid, gas, or colloidal dispersion precursor is used after a plasma treatment operation.

58. The method according to claim 55, further comprising a step of subjecting said material to a finishing step in a noble gas plasma phase.

59. The method according to claim 55, wherein said plasma affects said surface before liquid, gaseous or vapor mixture or colloidal dispersion treatment.

60. The method according to claim 31, further comprising a step of performing after a first plasma treatment at least a second plasma treatment on said surface.
